(19) United States
(12) Patent Application Publication
(10) Pub. No.: US 2007/0049351 A1
(43) Pub. Date: Mar. 1, 2007

(54) Wireless earpiece

(76) Inventor: William Frederick Ryann, San Antonio, TX (US)

Correspondence Address: William F. Ryann, Ste. 1629, 115 E. Travis St., San Antonio, TX, 78205, US

(21) Appl. No.: 11/218,391

(22) Filed: Aug. 29, 2005

(51) Int. Cl. H04M 1/00

(52) U.S. Cl. 455/569.1

(57) ABSTRACT

A wireless earpiece assembly configured with a casing to at least optionally be secured to an upper garment of a user. The assembly is configured to distribute a significant portion of its weight and bulk away from the isolated location of a user's ear for long term user comfort without sacrifice of audio or communicational integrity. The wireless earpiece assembly simultaneously minimizes the use of wiring employed, in order to optimize the un-encumbering user-friendly advantages afforded by wireless technology.

### BACKGROUND

Embodiments described relate to earpieces for coupling or pairing to an audio device. In particular, embodiments relate to earpiece assemblies for wireless pairing to mobile audio devices such as cell phones.

### BACKGROUND OF THE RELATED ART

Mobile audio devices are experiencing a dramatic growth in utilization. Such devices have evolved from transistor radios, televisions and mobile cassette players to more modern communication devices such as the mobile cell phones of today. Recently, it has become commonplace for mobile audio devices to incorporate non-audio functionality, such as cell phones incorporating picture taking, calendaring, e-mailing, internet web browsing, and other features. Similarly, different types of mobile audio devices are beginning to merge, such as cell phones that include the capacity to play digital music.

As mobile audio devices continue to play an ever increasing role in people's lives, the importance of ergonomic utilization of such devices has also increased. For example, an audio output mechanism such as an earpiece or headphones is often wired to a handheld mobile audio device such as a cell phone. In this manner, the cell phone need not be held right at the user's ear during operation. The wired earpiece allows the cell phone to be kept away from the user's ear without requiring use of less discrete means such as a speakerphone function. Use of a wired earpiece with the cell phone in this manner provides a degree of hands-free user-friendliness. Keeping the user's hands more free can improve safety when the user is simultaneously engaged in other tasks. For example, in many jurisdictions, hands-free use of cell phones has become required by law during operation of a motor vehicle as a matter of public safety.

In order to further address ergonomic, hands-free, and other user-friendly objectives when utilizing a mobile audio device an earpiece may be employed in a wireless manner. For example, wireless earpieces have been conceived and developed which do not require physical wiring directly to the mobile audio device. That is, a wireless earpiece may be secured at a user's ear with a cell phone wirelessly coupled or “paired” thereto. In this manner, cumbersome wiring from the earpiece all the way to the cell phone is eliminated. The cell phone may even be somewhat remote from the user during use. For example, the driver of an automobile may be using a cell phone via a wireless earpiece while the potentially distracting cell phone easily remains away from the driver's hands or immediate vicinity.

Unfortunately, a high quality wireless earpiece must be of dramatically increased size as compared to a traditional wired mechanism. This is because, in order to provide high quality wireless capability, the wireless earpiece is equipped with a power source, microphone, transceiver, antenna, microprocessor, and potentially other components, all of which are not required in a traditional wired earpiece. In a traditional wired earpiece there is present a physically wired connection to the cell phone where such components can be maintained, distributed, or rendered unnecessary altogether. However, the nature of a wireless earpiece necessitates the inclusion of wireless and other components right at the earpiece. Thus, the earpiece often includes a large casing for housing all of these components in addition to providing a speaker and other traditional wired earpiece components.

As an alternative to a heavy bulky casing, inductive loop and other similar devices may be available, but are generally much less desirable. Inductive loop devices involve the inherent cumbersome nature of forming an inductive loop about the user and result in generally low audio integrity and overall quality.

The large wireless earpiece described above is naturally of some increased weight. This weight, supported almost exclusively at the user's ear, may be from 0.75 to 2.0 ounces. By way of comparison, this is as much as eight times the weight of even the largest of standard sized earrings. In addition to the increased weight, a wireless earpiece, is generally configured with a casing large enough to house the above noted components. The casing is configured to rest over, behind, or around the back of the user's ear. Thus, the user's ear is forced to bear the bulk of the entire earpiece. In total, this may include a casing having a bulk of 3 to 5 inches across and up to ¾ of an inch wide or more, all resting right at the user's ear, sandwiched between the user's ear and head, blocking the auditory canal of the user's ear, or taking some other bulky or cumbersome configuration.

Employing a wireless earpiece, weighing as much as eight times that of a large earring, and further contributing extensive bulk at the user's ear sacrifices long term user comfort for the short term user-friendliness provided by the wireless nature of the earpiece. Extensive wear of such wireless earpieces can be quite uncomfortable, require frequent placement, replacement, and repositioning, and render the user-friendliness of ‘wireless capacity’ to be of diminishing value to the user. Furthermore, attempts to redistribute the bulk and weight of such wireless earpiece components away from the user's ear to other nearby accessories, such as eyewear or headwear similarly sacrifice user-friendliness. For example, the user may not require or desire wearing prescription glasses, sunglasses, hats, headphones, or other cumbersome and otherwise generally unnecessary accessories.

### SUMMARY

An earpiece assembly is provided for wireless pairing to an audio device. The assembly includes a speaker wired to a casing for securing to an upper garment of a user.

### BRIEF DESCRIPTION OF THE DRAWINGS

FIG. 1 is a side perspective view of an embodiment of a wireless earpiece assembly worn by a user.

FIG. 2 is a front perspective view of the wireless earpiece assembly of FIG. 1 worn by a user.

FIG. 3 is an opposing side view of an earpiece portion of the wireless earpiece assembly of FIG. 1.

FIG. 4 is a perspective sectional view of a casing of the wireless earpiece assembly of FIG. 1.

FIG. 5 is a side perspective view of an alternate embodiment of a wireless earpiece assembly.

FIG. 6 is a flow chart summarizing an embodiment of employing a wireless earpiece assembly.

### DETAILED DESCRIPTION

Embodiments are described with reference to certain earpiece assemblies having wireless features. These may include single ear earpiece assemblies or those delivering sound to both of a user's ears in stereo akin to traditional headphones. Regardless, embodiments described herein may be particularly useful when a wireless earpiece assembly is to be worn for any extended period of time. Additionally, this patent document has been filed in conjunction with Wireless Earpiece Assembly of William F. Ryann, which is hereby incorporated herein by reference in its entirety. A complete text of this document has been provided with this filing.

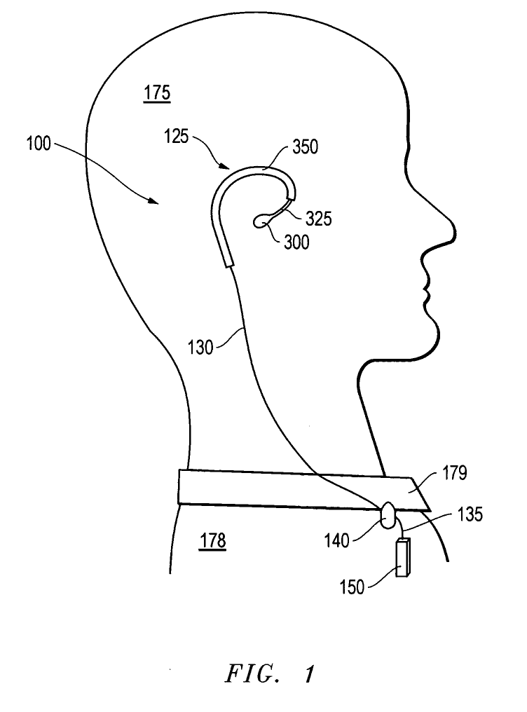

Referring to FIG. 1, an embodiment of a wireless earpiece assembly 100 is shown. The wireless earpiece assembly 100 is an earpiece assembly incorporating some wireless capacity. In the embodiment of FIG. 1, wireless transmission may come from a component within a casing 150, as described further herein. The wireless earpiece assembly 100 also includes a single earpiece portion 125 secured behind an ear 177 of a user 175 and having a speaker 300 for delivery of sound to an ear 177 of a user 175. However, a dual ear configuration may also be employed. For example, in one embodiment, multiple wireless earpiece assemblies 100 may be employed simultaneously. Additionally, in another embodiment, the speaker 300 may be secured at the ear 177 through alternative means. For example, the speaker 300 may be secured by a coupling mechanism fastened or secured to an outer ear location of the ear 177, such as at an ear lobe.

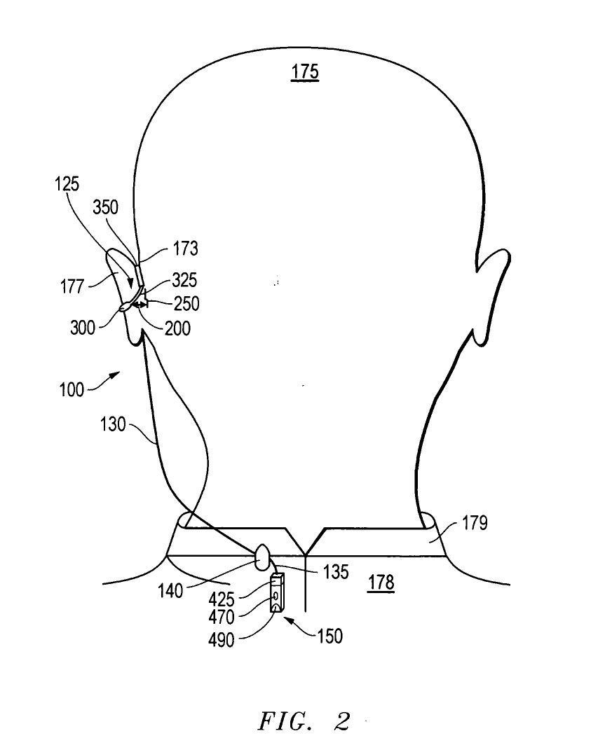

Referring to the particular embodiments of FIGS. 1 and 2 in more detail, the single earpiece portion 125 is shown secured behind an ear 177 of a user 175 as noted above. The earpiece portion 125 is physically coupled to the casing 150, described above, via conventional conductive wiring 130. This allows for communication between the earpiece portion 125 and components 400 within the casing 150 as described further herein.

Continuing with reference to FIGS. 1 and 2, the wiring 130 is shown secured through a clip 140. The clip 140 may be a small conventional support clip 140, perhaps between about 0.5 and 1.0 inches in length and somewhat smaller in width and depth. However, a variety of alternate clip 140 sizes, shapes and configurations may be employed. For example, the configuration of the clip 140 may be based on the weight of the casing 150 suspended therefrom, as described further herein, or other utilitarian factors. The clip 140 may additionally incorporate characteristics of size, shape, or color dependent on the aesthetic preferences of the user 175. In the embodiment shown, the clip 140 is separated from the casing 150 by a distal portion 135 of the wiring 130. However, in an alternate embodiment the clip 140 may be integral with the casing 150, and the wiring 130 may further be partially retractable into a portion of the casing 150, allowing the user 175 to exercise a degree of control over the length of exposed wiring 130.

As shown in FIGS. 1 and 2, the wiring 130 is secured through the clip 140 terminating at a casing 150. In one embodiment, the clip 140 may be proximally and distally mobile about the wiring 130, or otherwise insecure relative to the wiring 130 before positioned as shown. In this embodiment, the clip 140 may be secured to an upper garment 178 of the user 175, for example, at a shirt collar 179. The wiring 130 may then subsequently be positioned according to user preference and substantially immobilized through the clip 140 by conventional means. For example, the wiring 130 may be immobilized at the clip 140 by tightening or securing with a conventional clamp, tortuous positioning of the wiring 130 through the clip 140, or other securing feature integral to the clip 140. Alternatively, the wiring 130 may be integral with the clip 140 and permanently positioned in an immobilized fashion therethrough.

As described further herein, a substantial portion of the bulk and weight of the wireless earpiece assembly 100 is found at the casing 150 where several components 400 of the wireless earpiece assembly 100 are housed. Furthermore, the weight of the casing 150 itself is ultimately supported by, and distributed across, an upper garment 178 of the user 175. That is, the clip 140 is secured to the upper garment 178 while securely immobilizing the wiring 130. Thus, rather than being supported by the earpiece portion 125 and the ear 177 of the user 175, the weight of the casing 150 is translated across a distal portion 135 of the wiring 130 to the clip 140 and upper garment 178 of the user 175. Translating a substantial portion of the bulk and weight of the wireless earpiece assembly 100 away from the earpiece portion 125 in this manner enhances comfort for the user 175, especially at the ear 177, during extended wear.

In embodiments described above, much of the bulk and weight of the wireless earpiece assembly 100 has been translated to the particular location of an upper garment 178 of the user 175. The upper garment 178 is in fairly close proximity to an ear 177 of the user 175 which is advantageous considering that a purpose of the wireless earpiece assembly 100 is delivery of sound. In fact, with respect to the ear 177 of a user 175, an upper garment 178 is one of the nearest commonly worn pieces of apparel of substantial size available for supporting some of the bulk and weight of the wireless earpiece assembly 100. Thus, the length and amount of wiring 130 between the earpiece portion 125 and the casing 150 may be kept to a minimum.

In keeping wiring 130 to a minimum as described above, the embodiments shown in FIGS. 1 and 2 are configured for securing the casing 150 exclusively to a location as near the ear 177 of a user 175 as an upper garment 178 of the user 175. In fact, the embodiments shown reveal a configuration for securing the casing 150 exclusively to an upper portion of an upper garment 178 of the user 175 (e.g. at a shirt collar 179). Thus, embodiments of a wireless earpiece assembly 100 may include wiring 130 of no more than about 15 inches in total length, optimizing mobility and user-friendliness in an un-encumbering manner. In one embodiment, the wiring 130 is less than about one foot in length. This is in sharp contrast to a conventional earpiece assembly wired directly to an audio or other device and generally including at least about 40-55 inches of wiring or more.

As described further herein, embodiments of the wireless earpiece assembly 100 include wireless features such as a capacity for wireless transmission to and/or from a handheld or mobile device such as a cell phone. Limiting the wiring 130 to no more than about 10-15 inches as described above, substantially retains the hands-free and user-friendly aspects of employing wireless features. In fact, the wiring 130 which is present is not only kept to a minimal in length, but it is also uniquely positioned out of the way of the user 175 in an un-encumbering manner. As shown in FIGS. 1 and 2, and described above, the wiring 130 is short, off to the side, and naturally away from hands or other extremities of the user 175. In fact, in the embodiment shown, the wiring 130 would generally not even be in the line of sight of the user 130. Therefore, the hands-free wireless aspects of the wireless earpiece assembly 100 itself may be fully enjoyed.

Additionally, while it would be possible to translate the above mentioned weight and bulk to locations other than an upper garment 178 such as to eyewear or headwear, an upper garment 178 has the unique advantage of being everyday wear for most of the world. This is especially true of the world making regular use of devices such as the described wireless earpiece assembly 100. By way of comparison, hats, headphones, sunglasses, prescription glasses, and other garments or accessories generally worn above the neckline are not necessarily everyday wear for most people. Some form of upper garment 178, on the other hand, such as a shirt, blouse, dress, jacket, vest, sweater or other top is worn almost everyday by almost everyone.

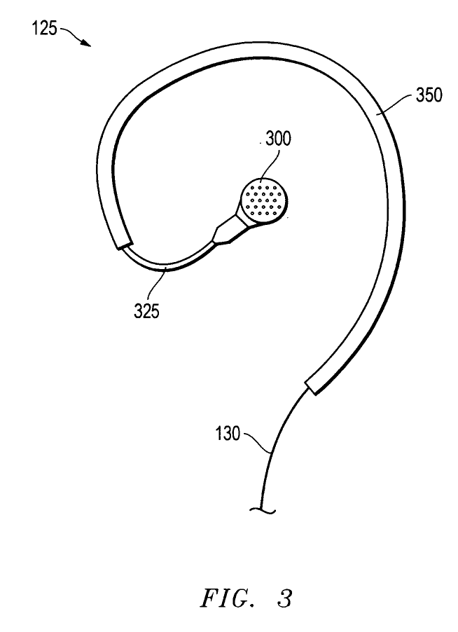

Referring now to FIGS. 2 and 3, particular features of one embodiment of an earpiece portion 125 of the assembly 100 are described in greater detail. In the embodiment shown, the earpiece portion 125 includes an ear support 350 for wrapping around and behind the ear 177 of a user 175, keeping the earpiece portion 125 stabilized. The ear support 350 may be of a conventional plastic or polymer material, including fluoropolymers and polymer foams. In fact, any compatible material having both stable and somewhat flexible physical characteristics for placement and use as shown in FIG. 2 may be employed.

The ear support 350 described above may have a width of less than about 0.25 inches, providing a comfortable fit between the ear 177 and the head 173 of a typical user 175. Additionally, the overall size of the ear support 350 may be determined according to common ear sizes. For example, measuring in a diameter-like fashion, the ear support 350 may be between about 2.0 inches and about 2.5 inches across at its widest portion or 3 to 4 inches circumferentially. However, other sizes may be made available. Additionally, some combination of the wiring 130 of the wireless earpiece assembly 100 and a portion of the speaker support 325 may removably pass through the ear support 350, as described further herein. In this manner, one size ear support 350 may be removed and replaced with one of different diameter sizing.

Continuing with reference to FIGS. 2 and 3, the wiring 130 terminates at a speaker support 325. The speaker support 325 is physically coupled to the ear support 350 by conventional means. In order to maintain electrical conductivity to the speaker 300, the speaker support 325 may include an electrically conductive core. For example, the speaker support 325 may be a dual conductor wiring with a configuration akin to conventional speaker wiring and perhaps similar to the main wiring 130 described above. In this manner, the speaker 300 may be conductively employed by conventional means. However, in the embodiment shown, the speaker support 325 is also configured to support the speaker 300 with a separation 200 as described further below. Therefore, the speaker support 325 may be of heavy gauge wiring configured to retain a manually user-defined shape. That is, the speaker support 325 may be conformed to a stable and naturally retainable configuration by a user 175 as shown in FIG. 2. Alternatively, the speaker support 325 may include conventional higher gauge wiring through a non-compliant cylindrical passage positioned as shown.

In order to achieve both conductivity and stable conformation, embodiments of a speaker support 325 may include between about 8 and about 20 gauge dual conductor metal wiring, most preferably of copper. However, the particular gauge, overall dimensions, and materials selected for the speaker support 325 will be based in part on the weight of the supported speaker 300. For example, in one embodiment, the speaker support 325 may include 16-18 gauge dual copper wiring, with each line independently insulated with up to about 15 mils of a polyethylene, nylon, or other conventional insulating jacket. Such a speaker support 325 would reliably and stably support a conventional earpiece speaker 300 of at least about 0.25 ounces. Additionally, in this embodiment, the speaker support 325 would be no wider across, in diameter or otherwise, than about 0.2 inches, well sized for coupling to closely sized conventional wiring 130 or other conducting means through the ear support 350.

Referring specifically to FIG. 2, the stability and compliant nature of the speaker support 325 is shown in the user-defined separation 200 that is formed and stably maintained between the speaker 300 and an adjacent ear surface 250. The speaker 300 is shown positioned in line with an auditory canal of the user 175. As described above, the separation 200 may be a result of the user 175 manually shaping the speaker support 325 to the conformation shown based on the user's own personal preference and comfort. Thus, the user 175 is able to keep the speaker 300 off of the ear 177 and ear surface 250 allowing for greater user comfort, especially where the user 175 employs the earpiece portion 125 for an extended period of time.

The above-noted separation 200 may be anywhere up to about 0.5 inches depending on the comfort or preference of the user 175. The separation 200 also allows the ear 177 and auditory canal of the user 175 to remain open and unblocked for hearing other sound when the wireless earpiece assembly 100 is in place but not in use. Therefore, the wireless earpiece assembly 100 need not be removed and replaced continuously in order to facilitate good hearing of sound from outside the speaker 300 between uses. Furthermore, the stable nature or heavy gauge of the speaker support 325 allows it to retain its shape once conformed thereto by the user 175. Thus, the user 175 also need not continually shape and position the speaker support 325 upon each use of the earpiece portion 125.

Given the presence of a separation 200 as described above, the speaker 300 employed may be directional in nature. That is, the speaker 300 may employ available and evolving hypersonic sound (HSS) capacity in order to focus or direct sound to the auditory canal of the user 175. In this way, the sound transferred from the speaker 300 is focused across the separation 200, specifically to the user 175. Thus, the separation 200, provided for the comfort of the user 175 is not achieved at the expense of maintaining quality and personal integrity of the sound transferred from the speaker 300 to the user 175. Rather, employing hypersonic sound (HSS) capacity in the speaker 300 delivers quality sound to the user 175 and prevents others nearby from overhearing or being distracted by the sound emanating from the speaker 300.

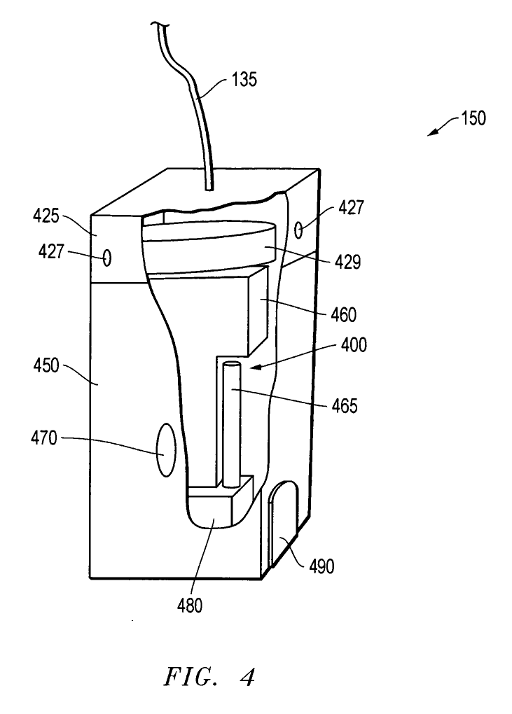

Referring now to FIGS. 2 and 4, the casing 150 is described in further detail. In the embodiment shown, the casing 150 with components 400 therein, includes about half of the weight of the entire wireless earpiece assembly 100. Thus, given that the casing 150, clip 140 and distal portion 135 of the wiring 130 are all supported from the upper garment 178, as described above, most of the weight of the wireless earpiece assembly 100 is supported by the upper garment 178. For example, in one embodiment, the weight of the entire wireless earpiece assembly 100 is between about 0.7 and about 0.9 ounces, whereas the weight of the casing alone may be about 0.4 ounces. Additionally, as shown in FIG. 2, the casing 150 is secured in a user-friendly location where its particular shape and bulk are of minimal significance to the comfort of the user 175. The casing 150 may also have a second earpiece portion and wiring coupled thereto for providing stereo sound to the user 175.

Continuing with reference to FIGS. 2 and 4, the casing 150 includes an outer shell 450 configured to house several components 400 of the wireless earpiece assembly 100. In the embodiment shown, the casing 150 includes a microprocessor 460 coupled to other components 400 of the casing 150 for directing interaction therebetween. The casing 150 further includes a microphone portion 425 with a microphone 429 resting adjacent sound inlets 427. The microphone 429 may be a focused microphone such as an array microphone to enhance audio reception thereat should the casing 150 be positioned away from the user's mouth to some degree. Additional components 400 of the casing 150 include a conventional transceiver and antenna assembly 465 along with a power source 480 for the wireless earpiece assembly 100.

Other optional components 400 of the casing 150 include a light emitting diode 470 (LED) and an actuator 490 for physical manipulation by the user 175. For example, when the wireless earpiece assembly 100 is paired to a cell phone, the LED 470 may act as an indicator of a paired connection, or an incoming call. Similarly, the user 175 may manipulate the actuator 490 for communicating with the microprocessor 460 to direct acceptance of an incoming phone call over the wireless earpiece assembly 100 from the cell phone.

In the embodiments shown, the actuator 490 is the controlling physical interface between the user 175 and the wireless earpiece assembly 100. As a result, the physical security and stability of the wireless earpiece assembly 100 is of greatest concern at the site of the actuator 490. Therefore, in embodiments shown, the actuator 490 is located at the secured casing 150 rather than, for example, at the earpiece portion 125 or other location above the clip 140, where regular physical manipulation risks user discomfort or displacement of the earpiece portion 125.

With particular reference to FIG. 4, the particular components 400 provided at the casing 150 may vary. For example, the microphone 429 may be provided integral with the wiring 130 at the distal portion 135 thereof or other components 400 provided at the earpiece portion 125 or elsewhere. However, the more components 400 provided in a manner to be supported or suspended from the clip 140, the less the overall bulk and weight of the wireless earpiece assembly 100 that must be borne at the ear 177 of the user 175.

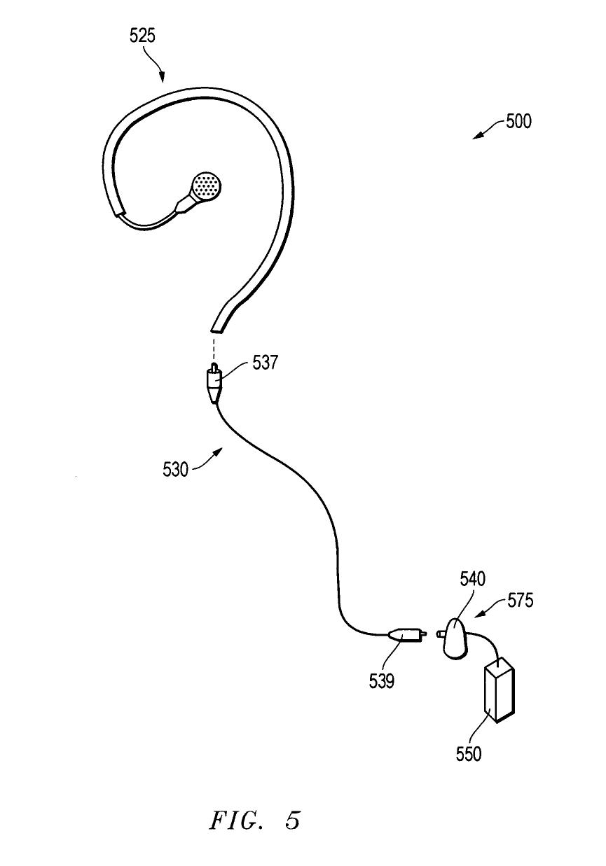

Referring to FIG. 5, an alternate embodiment of a wireless earpiece assembly 500 is shown. In this embodiment, interchangeable or removable wiring 530 is used to couple the earpiece 525 and a casing subassembly 575. As shown, a distal coupling 539 of the removable wiring 530 may be removably coupled to the casing subassembly 575, whereas a proximal coupling 537 may be removably coupled to the earpiece 525. The earpiece 525 is otherwise configured as described with respect to other embodiments above. Similarly, the casing subassembly 575 includes a casing 550 and clip 540 configured as described with respect to other embodiments above, with the exception of removable coupling to the removable wiring 530 described here.

Continuing with reference to FIG. 5, alternate removable wiring 530 lengths may be made available. Thus, the distance between the casing subassembly 575 and the earpiece 525 may be particularly selected by the user, depending on the user's own personal dimensions and preferences. Additionally, the removable wiring 530 may be coupled to an assembly other than the casing subassembly 575 shown. For example, the removable wiring 530 may be coupled to headwear, eyewear, or other above-neckline-apparel capable of accommodating conventional components otherwise housed at the casing subassembly 575. Thus, the removable wiring 530 provides the wireless earpiece assembly 500 with user-friendly options related to sizing and component housing alternatives.

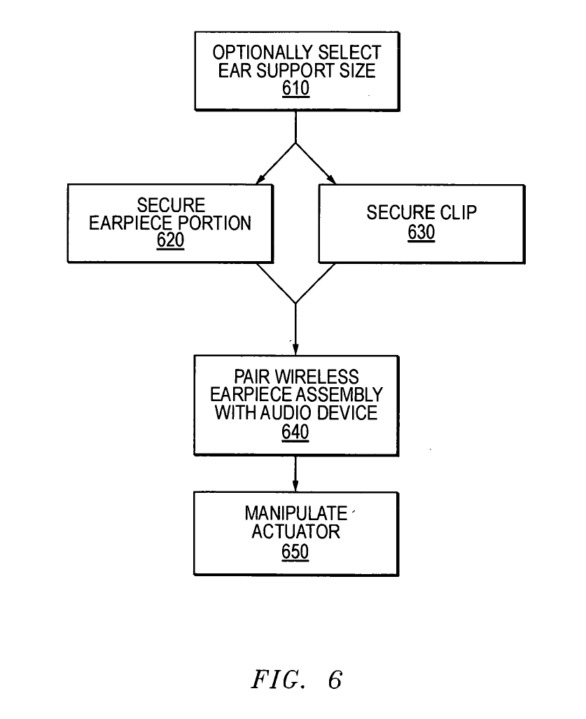

Referring now to the flow-chart of FIG. 6, and with additional reference to FIGS. 1-5, an embodiment of employing a wireless earpiece assembly 100 is described. As referenced above, the wireless earpiece assembly 100 may be fitted with an ear support 350 of a particular size and shape according to preference of the user 175 as indicated at 610. As described above with reference to FIG. 5, other user-defined preferences such as length of wiring 530 may also be optionally taken advantage of.

Once configured to the liking of the user 175, a wireless earpiece assembly 100 may be positioned for use by securing an earpiece portion 125 to the ear 177 of the user 175 and a clip 140 and casing 150 to an upper garment 178 of the user 175 (as indicated at 620 and 630). Once in place, the wireless earpiece assembly 100 may be wirelessly coupled or “paired” to an audio device as indicated at 640. For example, the wireless earpiece assembly 100 may be paired to a mobile audio device such as a cell phone in order to provide the user 175 with a more hands-free user-friendly mode of communication. Additionally, control of the wireless communication between the wireless earpiece assembly 100 and the audio device may be directed by the user 175 through manipulation of an actuator 490 at the secured casing 150 as indicated at 650.

Embodiments described above provide a wireless earpiece assembly 100, 500 configured to minimize the uncomfortable effects of bulk and weight to a user 175 employing such an assembly 100, 500, especially during long term wear. The embodiments described also simultaneously optimize the user-friendly, hands-free and non-cumbersome advantages afforded by wireless technology, for example, by employing minimal total wiring 130, 530 positioned out of the way of the user 175.

Although exemplary embodiments describe particular wireless earpiece assemblies configured with a casing for securing exclusively to an upper garment of a user, additional embodiments are possible. For example, a wireless earpiece assembly may be configured to also optionally couple directly to headwear or eyewear accommodating casing components, in place of the casing itself. Additionally, the wireless earpiece assembly may be configured for pairing to a host of audio devices not limited to mobile cell phones as described hereinabove. Furthermore, many changes, modifications, and substitutions may be made without departing from the spirit and scope of the described embodiments. For a period following publication of this application and/or patent, a copy hereof may be made available at www.Licentia-IP.com.

I claim:

1. An earpiece assembly for wireless pairing to an audio device and comprising:
a speaker for securing at a user's ear; and
a casing coupling to said speaker and for securing to an upper garment of the user, said casing for housing a component of the earpiece assembly.

2. The earpiece assembly of claim 1 wherein the component is one of a transceiver and antenna assembly for the wireless pairing, a microprocessor, a microphone, a power source, a light emitting diode, and an actuator for physical manipulation by the user.

3. The earpiece assembly of claim 1 wherein said casing is of a weight at least about half that of said earpiece assembly.

4. The earpiece assembly of claim 1 wherein said casing is for securing to an upper portion of the upper garment.

5. The earpiece assembly of claim 1 wherein said casing is for securing exclusively to the upper garment.

6. The earpiece assembly of claim 1 wherein the speaker is a first speaker and the user's ear is a first ear, said earpiece assembly further comprising a second speaker for securing at a user's second ear and coupled to said casing.

7. The earpiece assembly of claim 1 further comprising an ear support for the securing of the speaker, said ear support configured for fitting behind the user's ear and having a width of less than about 0.25 inches.

8. The earpiece assembly of claim 1 further comprising a clip coupled to said casing, said clip for the securing to the upper garment.

9. The earpiece assembly of claim 8 further comprising wiring terminating at said casing for the coupling.

10. The earpiece assembly of claim 9 wherein said wiring is less than about 15 inches in length.

11. The earpiece assembly of claim 9 wherein said wiring is of a length limited to within a distance between the ear and the upper garment.

12. The earpiece assembly of claim 9 wherein said wiring is at least partially retractable into a portion of said casing.

13. The earpiece assembly of claim 9 wherein said wiring passes through a portion of said clip, a distal portion of said wiring separating said clip and said casing.

14. The earpiece assembly of claim 13 further comprising a microphone integral with the distal portion of said wiring.

15. The earpiece assembly of claim 9 wherein said clip is proximally and distally mobile about said wiring.

16. The earpiece assembly of claim 15 wherein said clip includes a capacity to immobilize said wiring therethrough.

17. An earpiece assembly for wireless pairing to an audio device and comprising:
a speaker for securing at a user's ear; and
wiring coupling to said speaker and for optionally coupling further to one of a casing for securing to an upper garment of the user and above-neckline-apparel of the user, the casing and the above-neckline apparel for housing a component of the earpiece assembly.

18. The earpiece assembly of claim 17 wherein said wiring is of a given length and interchangeable by the user for alternate wiring of a different length.

19. An earpiece comprising:
an ear support for placing behind a user's ear and securing the earpiece thereat;
a speaker for delivering sound to the user's ear; and
a speaker support for electrical and physical coupling of said speaker to said ear support, said speaker support to provide a stable separation between said speaker and the user's ear.

20. The earpiece of claim 19 wherein said speaker support is less than about 0.2 inches wide.

21. The earpiece of claim 19 wherein said speaker support is of conformable wiring configured to stably retain a user-defined shape.

22. The earpiece of claim 21 wherein the conformable wiring is between about 8 gauge and about 20 gauge.

23. A method of wirelessly employing an earpiece assembly and comprising:
securing a speaker of the earpiece assembly at a user's ear; and
securing a casing coupled to the speaker to an upper garment of the user, the casing housing a component of the earpiece assembly.

24. The method of claim 23 further comprising wirelessly pairing the earpiece assembly to an audio device.

25. The method of claim 24 wherein the audio device is a mobile cell phone.

26. A method of wirelessly employing earpiece assemblies and comprising:
securing a speaker of a first earpiece assembly at a user's first ear;
securing a first casing coupled to the speaker of the first earpiece assembly to an upper garment of the user;
securing a speaker of a second earpiece assembly at a user's second ear; and
securing a second casing coupled to the speaker of the second earpiece assembly to the upper garment of the user, the first casing and the second casing each housing an earpiece assembly component.

27. The method of claim 26 further comprising delivering stereo sound to the user's first and second ears with the speakers of the first and second earpiece assemblies.
